(19) United States
(12) Patent Application Publication
(10) Pub. No.: US 2019/0190765 A1
(43) Pub. Date: Jun. 20, 2019

(54) Controller for detection of Bluetooth Low Energy Packets

(71) Applicant: REDPINE SIGNALS, INC., San Jose, CA (US)

(72) Inventors: Partha Sarathy MURALI, Sunnyvale, CA (US); SuryaNarayana Varma Nallaparaju, Vizianagaram (IN)

(73) Assignee: REDPINE SIGNALS, INC., SAN JOSE, CA (US)

(21) Appl. No.: 16/221,368

(22) Filed: Dec. 14, 2018

Related U.S. Application Data
(60) Provisional application No. 62/599,562, filed on Dec. 15, 2017.

(51) Int. Cl. H04L 27/26; H04L 27/00

(52) U.S. Cl. CPC H04L 27/2692; H04L 2027/0095; H04L 27/0014; H04L 27/2613

(57) ABSTRACT

A preamble detector for Bluetooth Low Energy includes a receiver for receiving Bluetooth packets and an energy detect controller for enabling power to the receiver during T1 and disabling power to the receiver during T2 in a cyclical fashion until an packet energy increase is detected followed by detection of a preamble. During the T1 interval an AGC process is operative which is also searching for an increase in energy from sample to sample within the same T1 interval, or across adjacent T1 intervals. If an energy increase is detected, a preamble detector is operative to determine if a preamble is present, and if the preamble is not present, the process resumes cycling through T1 and T2.

### FIELD OF THE INVENTION

The present invention relates to an apparatus and method detection of Bluetooth packets. In particular, the invention relates to detection of Bluetooth Low Energy (BLE) packets.

### BACKGROUND OF THE INVENTION

In low power communications equipment, it is desired to reduce the power consumption requirements. For a battery powered network station, the current consumption governs battery life. For some communications protocols, such as the beacon frame of 802.11, it is possible to selectively power the station on during those times to save power. However, for a receiver operative on the Bluetooth protocol, the packets may asynchronously arrive, requiring that the network station be powered continuously.

It is desired to provide a method for reducing power consumption in a wireless Bluetooth receiver which may receive packets from remote stations, while ensuring that no such packets are missed.

### OBJECTS OF THE INVENTION

A first object of the invention is a low power receiver for Bluetooth Low Energy (BLE) wireless packets, the BLE wireless packets having a Bluetooth preamble length of Tpre, the wireless receiver having a preamble detection time of Tpd, the low power receiver performing a series of variable length preamble detection cycles, each cycle of length Tcyc having a duration equal to or less than a shortest expected packet preamble to be detected, each Tcyc having an operative interval T1 for sampling a received energy level and comparing a previous value to a current value for an energy increase larger than a threshold, the low power receiver powering down during a subsequent T2 interval, the length of the T1 interval and T2 intervals being selected such that T1 is sufficient to allow detection of energy from a preamble followed by detection of the preamble itself, while reducing the consumed power during T2 intervals.

A second object of the invention is a controller for a receiver receiving Bluetooth wireless packets, the receiver providing samples of a baseband signal using an analog to digital converter, the controller operative over a series of cycles of T1 and T2 intervals, the controller powering the receiver on during each T1 interval and removing power from said receiver during each T2 interval, the controller sampling the baseband signal during T1 intervals to perform an automatic gain control (AGC) process and also determining whether an energy level increase occurred from a previous sample to a current sample, and asserting a packet detect and keeping power applied to the receiver when an energy level increase above a threshold occurs.

### SUMMARY OF THE INVENTION

A receiver for Bluetooth Low Energy (BILE) packets has an analog front end (AFE) for amplification and conversion of received wireless signals to baseband, analog to digital converters to digitize the baseband signal, and an energy detector coupled to the analog to digital converter for detecting an energy rise in the baseband signal. The wireless receiver is powered on for a nominal interval T1 during which energy sampling occurs on the analog to digital outputs and then the receiver is powered down during a second interval T2, where T1+T2 has a cycle time Tcyc which is equal to, or shorter than, a preamble of the wireless packet to be detected, such that both energy detection and preamble detection may occur during the T1 interval. In an example embodiment, the wireless packets are sampled by an analog to digital converter for detection of energy increase from a previous sample to a current sample or over a history of samples to a current sample. In this manner, the receiver is able to detect a preamble in the shortened T1 interval and consume no power during the T2 interval.

### BRIEF DESCRIPTION OF THE DRAWINGS

FIG. 1 shows a prior art Bluetooth Low Energy packet format.

FIG. 2 shows a block diagram for a Bluetooth receiver.

FIG. 3 shows a plot of waveforms for operation of an example energy detect controller of FIG. 2.

FIG. 4 shows a flowchart for a packet detection process operative on an energy detect controller.

### DETAILED DESCRIPTION OF THE INVENTION

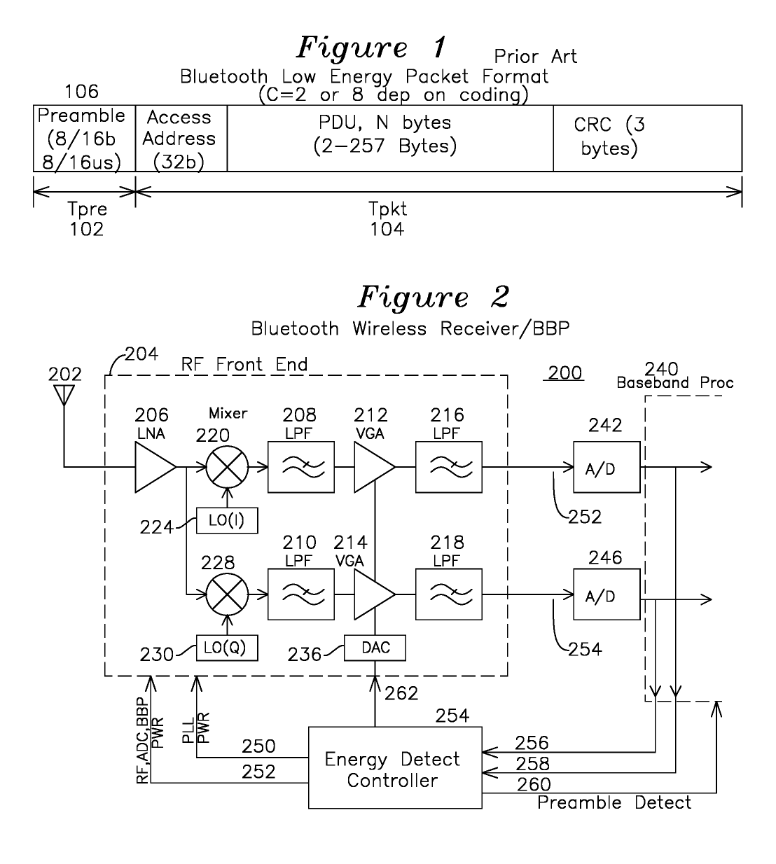

FIG. 1 shows a prior art Bluetooth Low Energy packet 100, which has a preamble field 102 approximately 8 us long, which is followed by various fields of the packet 104, including a 32 bit access address, variable length data part of the packet PDU, and a CRC for error checking and packet data validation. It is desired for the receiver to be powered on at periodic intervals to check for a preamble 106, and if a preamble is present, remaining powered on to recover the remainder of the packet fields 104, otherwise powering down until the next preamble detection period.

FIG. 2 shows an example RF receiver 200, having an antenna 202, RF front end 204 with low noise amplifier 206, quadrature mixers 220 and 228, local oscillators 230 and 224 for conversation of received RF to baseband, low pass (or optionally band pass) filters 208 and 210, variable gain amplifiers 212 and 214 for performing gain control, filters 216 and 218, and analog to digital converters 242 and 246, which are operative at a sufficiently low sample rate to detect an increase in received RF energy such as from a Bluetooth packet. Energy detect controller 254 generates the various signals for controlling the power distribution and signal examination for the various signals required for the energy detection to occur. Many other signals are required for operation as a Bluetooth receiver, but exemplar FIG. 2 is restricted to only the signals required for the operation of the invention. Phase lock loop (PLL) power 250 is an enable signal to provide power to the various PLLs and other oscillators which may require a settling time Tpll, which is approximately 6 us. Shortly after the PLL and other clocks are settled, RF/ADC power 252 is enabled so that all of the remaining functions required for preamble detection may occur.

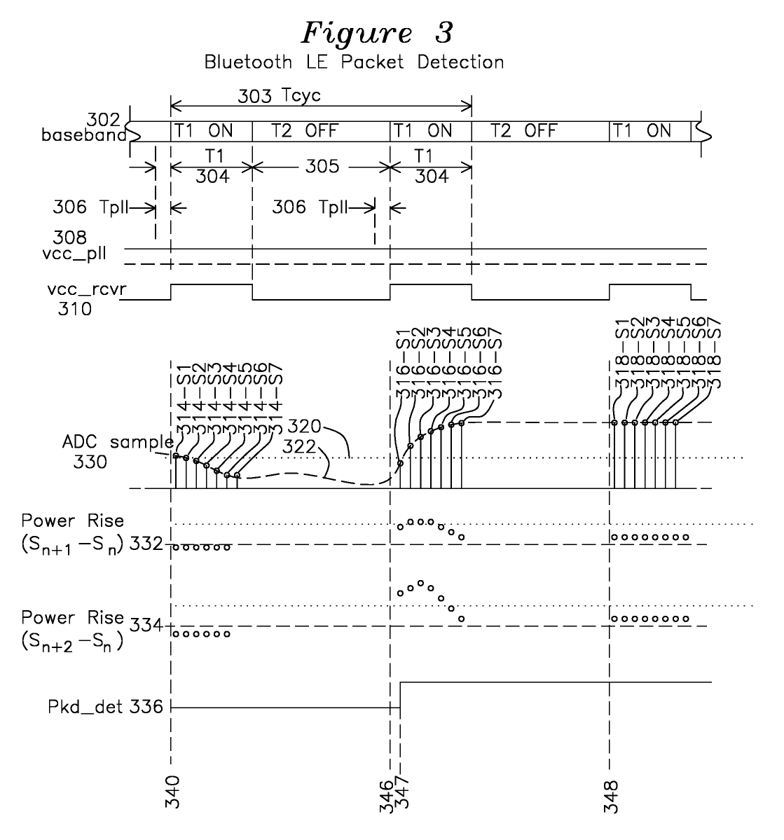

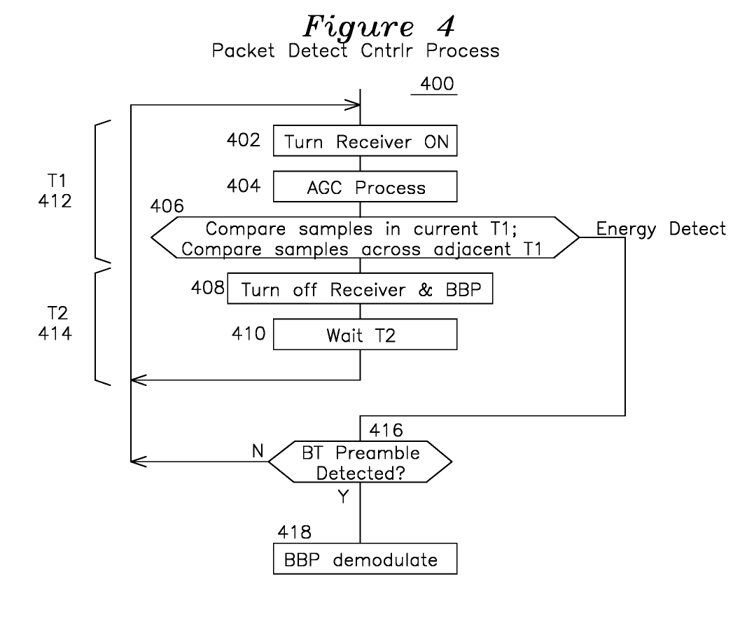

FIG. 3 shows example waveforms for the operation of the invention and controller 254 of FIG. 2. Sampling of the baseband RF is performed using A/D converters 242 and 246 of FIG. 2 which are operative on the baseband signal stream 302, which contains an additive mixture of RF from Bluetooth packets, noise, and interference from other stations in a continuous stream. The preamble detection is performed by cyclically sampling the baseband 302 signal with A/D converters 242 and 246 at a low rate during an operative T1 sample interval 304 followed by a T2 interval 305 where the receiver is powered off and no power is consumed. The T1 304 sample interval and T2 305 power down interval cyclically occur in a duration Tcyc 303, where Tcyc is equal to, or shorter than, the Bluetooth packet preamble. In the case of Bluetooth Low Energy, the packet preamble interval is 8 us long as shown in FIG. 1.

The BLE receiver 200 operates at 10 dB Signal plus Interference to Noise (SINR) ratio or higher. Signal to Noise ratios down to 6 dB can be reliability detected by checking for Power-rise on the Rx 1 MHz Filter output. This would save the power in the digital baseband processor 240 but it wouldn't save much power in the LNA, Rx Mixer, LO Buffer, Rx ABB and the ADC of the analog front end 204. One possible approach is for the RF receiver and ADC to turn ON and settle within 1 us and to employ fine grained duty-cycling. An example T1/T2 duty cycling when the receiver is listening for advertising frames is T1=2 us and T2=N us OFF, where N can be even as high as 10 us during listen and use the receiver effectively as an in-band (1 MHz) energy rise sensor. This first approach of duty-cycling the receiver on during T1 and off during T2 directly provides 2 to 4× savings in the listen power.

In one example of the invention, T1=2 us and T2=2 us. In this example, the worst case scenario is the preamble is coincident with T2, so the preamble energy is first detected 2 us into sampling, which leaves 6 us of preamble for the AGC to settle prior to decoding the address field 103 of FIG. 1. A second example case of T1=2 us and T2=4 us reduces the duty cycle and increases the power savings, but creates a worst case sampling scenario where the preamble energy is first detected 4 us into the preamble (where the preamble starts coincident with T2), leaving only 4 us for the AGC process to complete, which is not enough time for the AGC process to complete, so the AGC process will be operative into the access address field 103 before completing the AGC process. This second case can still be used for Bluetooth LE advertising frames, which have separate channels and the access code 103 used for advertising frames is robust. It is acceptable to not properly decode the access address 103 the first time that a scanning receiver receives and advertising frame because the slotting timeline between the master and slave is not yet established. Accordingly, the indication of a false access code correlation is not a problem during the initial advertising scan. In the preceding methods, a fine-grained power T1/T2 cycling of power to the RF front end 204, ADCs 242 and 246, and gain control 236 can be used for “power-rise” detection of the received signal energy, where “fine-grained” refers to sample times which are less than ½ or ¼ of a preamble symbol time of 8 us or bit time of 1 us. For these embodiments with the 8 us preamble 102, the RF PLL and any clock oscillators with a startup time are maintained in a powered up state as shown in waveform 308. An example range for T1 BLE scan values is 2 us-3 us. Example ranges for T2 are 2 us to 10 us. Typical values for the settling time for RF receiver are 0.5 us to 2 us, which is the advance turn-on time for the receiver prior to the T1 listen interval. In an example embodiment, controller 254 provides fine gain control of T1 and T2.

Ordinarily, AGC is performed prior to preamble detect. In an example embodiment, the AGC process is only operative during T1 when the RF is turned ON. By adjusting the AGC in several steps and oversampling each symbol, the AGC may complete during T1. For example, for an incoming stream of BLE symbols S1, S2, S3, S4, S5, S6, S7, each BLE symbol 1 us in duration may have 2 or 4 or 8 samples based on ADC sampling rate of 2 MSps or 4 MSps or 8 MSps, respectively. By oversampling each BLE sample to complete the AGC within a single 1 us symbol, a power rise can be detected, which then starts the AGC process and start the packet detect process of verifying the receipt of 106 preamble by the baseband processor 240.

In another example of the invention, the RF receiver and ADCs are turned off during the T2 period, with the clocking sources such as PLL and crystal oscillator continuing to run. During T1, the AGC is enabled, with the AGC process searching for the power rise in input signal. This is illustrated in the waveform 330, with ADC samples 314-S1, 314-S2, 314-S3, 314-S4, 314-S5, 314-S6 and 315-S7. In one example embodiment, each current sample Sn is compared to an adjacent symbol Sn−1 in the series of samples for each T1 interval as shown in 332, and in another example embodiment, the comparison is done between a current sample and Sn−2 in the samples of 334. By comparison of signal increase with a single T1 period (314-S1 to 314-S2 or 314-S3, 314-S5 to 314-S6 or 314-S7, for example, or across T1 periods (314-S7 to 316-S1 or 316-S2, for example), and by using a high rate of sampling (faster than 1 us per sample, so that multiple samples are taken from a single 1 us Bluetooth symbol) for the case of 2 us T1 and 2 us T2 with AGC performed over 2.5 us of preamble (extending just beyond T1), that would leave 3.5 us of preamble (worst case) for preamble detection and achieve close to 2× reduction in listen mode power.

In another embodiment of the invention, a one or two symbol buffer is placed in the sample path of the receiver, which would provide the ability for the preamble detector to start on a delayed copy of the stream of digitized signals. For example, the use of a 1 us buffer in the A/D path which precedes the receiver part would result in the loss of only 2.5 us of preamble in the worst case. In this embodiment, the AGC finetune of the last sample period should be applied by digital multiplication of the signal samples to avoid the time delay of analog AGC and to ensure the samples are presented with uniform gain adjustment. The increase in complexity of this approach is only valuable for non-advertising Bluetooth frames, as Bluetooth advertising frames do not use the access address field 103 which is affected by late agc completion.

FIG. 4 shows an example flowchart for the packet detect controller 254 of FIG. 2. During a T1 interval of the timing diagrams of FIG. 3, the receiver is powered ON 402 and the AGC process 404 is operating, both setting the signal level to an optimum level, and simultaneously making measurements of energy level, as shown in the sample series 314-S1 etc, 316-S1 etc, and 318-S1 etc. and power rise sample measurements of 332 and 334. Step 406 of examining power rise may be done concurrent with AGC 404 or separately, if an energy detect event occurs, a Bluetooth preamble detection process 406 occurs, examining the preamble for the 0xAA pattern, and continuing on to packet demodulation 418 if found, otherwise returning to the process step 402 at the end of T2. If no energy increase is detected in step 406, the receiver is powered off 408 for the T2 duration 410, and the cycle repeats at step 402. Because of the short preamble detection interval, oscillators and Phase lock loop (PLL) clock sources are continuously enabled through T1 and T2 to allow them to be operative during the T1 interval.

The present examples are provided for illustrative purposes only, and are not intended to limit the invention to only the embodiments shown. High speed and high frequency are understood to refer to the same characteristic, and low speed and low frequency are similarly understood to refer to the same characteristic. The use of claims terms such as “order of magnitude” is meant to include the range from 0.1× to 10× the nominal value, whereas “approximately” is understood to include the range of one half to two times the nominal value. The scope of the invention is limited only by the claims which follow.

We claim:

1) A system for detecting Bluetooth wireless packets having a preamble, said system having a receiver, an energy detection controller, and a preamble detector;
said receiver having an antenna coupled to an RF amplifier, a variable gain amplifier, a mixer for converting amplified RF signals to baseband signals, at least one analog to digital converter for sampling said baseband signals;
said energy detection controller coupled to said analog to digital converters and controlling the gain of said variable gain amplifier and also enabling power to said receiver during cycles of an interval T1 and an interval T2, the energy detection controller applying power to the receiver during each said interval T1 and removing power to said receiver during each said interval T2;
said preamble detector operative for detection of a Bluetooth preamble, said preamble detector coupled to the analog to digital converter output, said preamble detector asserting a preamble detect when a preamble is detected;
said energy detection controller performing an automatic gain control process during said T1 and also examining samples from said analog to digital converter, said energy detection controller asserting a packet detect output when successive samples of said analog to digital converter exhibit an increasing signal level above a threshold;
upon the assertion of said packet detect, said AGC process stopping and said preamble detector enabled to detect a preamble during the remainder of said T1;
said energy detection controller keeping said receiver powered on if a preamble detection occurs, said energy detection controller removing power from said receiver until a subsequent T1 cycle if a preamble detection does not occur.

2) The system of claim 1 where said T2 is approximately 2 us.

3) The system of claim 1 where said T2 is 2 us or greater.

4) The system of claim 1 where said Bluetooth packets are compatible with Bluetooth Low Energy (BLE) Packets.

5) The system of claim 1 where said receiver has clock signals generated with either phase lock loops or crystal oscillators which remain powered on during said T1 and said T2 intervals.

6) The system of claim 1 where said AGC process samples said analog to digital converters more frequently than 1 us per sample.

7) The system of claim 1 where said energy increase is determined by measuring the difference between a current sample energy level and a previous sample energy level.

8) The system of claim 1 where said previous sample is one or two samples earlier than a current sample.

9) The system of claim 1 where said AGC process, said packet detect, and said preamble detect occur in a time duration of a Bluetooth preamble.

10) A controller for detection of Bluetooth Low Energy preamble energy, the controller operative to power the receiver on during a T1 interval and powering the receiver off during a T2 interval, the receiver having an AGC process for controlling the gain of the receiver and providing an output indicating received energy level as a series of samples, the controller operative to detect an increase in signal level from a previous sample to a current sample, and when the increase in signal level exceeds a threshold, asserting a packet detect output.

11) The controller of claim 10 where said increase in signal level is from a previous sample to a current sample within a single T1 interval.

12) The controller of claim 10 where said increase in signal level is from a previous sample in a preceding T1 interval to a current sample in a following T1 interval.

13) The controller of claim 10 where said AGC process determines when said energy level increase occurred.

14) The controller of claim 10 where said AGC process, said energy increase detection and said preamble detection occur in 8 us or less.

15) The controller of claim 10 where said AGC process, said energy increase detection and said preamble detection occur in Bluetooth packet preamble interval.

16) The controller of claim 10 where said T1 is approximately 2 us and said T2 is approximately 2 us.
